(19) United States
(12) Patent Application Publication
(10) Pub. No.: US 2014/0241207 A1
(43) Pub. Date: Aug. 28, 2014

(54) METHOD AND APPARATUS FOR DISCOVERING NETWORK NODE

(71) Applicants: Yindong Zhang, Beijing (CN); Wei Wang, Beijing (CN); Bin Da, Beijing (CN); Haihua Yu, Beijing (CN)

(72) Inventors: Yindong Zhang, Beijing (CN); Wei Wang, Beijing (CN); Bin Da, Beijing (CN); Haihua Yu, Beijing (CN)

(73) Assignee: RICOH COMPANY, LTD., Tokyo (JP)

(21) Appl. No.: 14/187,424

(22) Filed: Feb. 24, 2014

(30) Foreign Application Priority Data
Feb. 28, 2013 (CN) 201310064506.4

(51) Int. Cl. H04W 8/00; H04W 84/18

(52) U.S. Cl. CPC H04W 8/005; H04W 84/18
USPC 370/254

(57) ABSTRACT

A method and an apparatus for discovering a node in a wireless self-organized network are disclosed. The method comprises the steps of determining, by nodes in the network, a unified node discovery channel based on unified information provided by a trusted third party; and finding the node based on the unified node discovery channel. According to the node discovering method, a node can be discovered rapidly, and the time for discovering a node can be reduced.

### BACKGROUND OF THE INVENTION

1. Field of the Invention

The present invention generally relates to a wireless communication network, and specifically, a method and an apparatus for discovering a node in a wireless self-organized (ad-hoc) network.

2. Description of the Related Art

A technology for discovering an equipment node is very important in a wireless peer-to-peer network. For example, the speed of the data transmission, the speed of the network connection, the safety of the network data transmission and an environment protection element of the network are usually important features of a wireless peer-to-peer network. However, if nodes in the network have to spend a long time to find other nodes, the user satisfaction will decrease with time. Several node discovery protocols for a wireless peer-to-peer network have been provided, however, in most of these protocols, the node discoveries are performed based on internal information of the network.

In U.S. Pat. No. 8,233,495B2, several channels are selected from all of the available wireless channels, which are called social channels; a node in a wireless peer-to-peer network selects a channel as “Discovery Channel” from the social channels, and sends a request in the discovery channel in the form of “Discovery Beacon”; another node determines whether the association between the another node and the node that sends the request has a benefit or not, when the “Discovery Beacon” is received by the another node; and the another node returns a response to the node that sends the request, when the benefit exists. In this way, the two nodes discover each other. However, in this patent, nodes select a “Discovery Channel” independently, and nodes select different “Discovery Channel”. Therefore, it is necessary for the node that sends a request, to scan all social channels so as to discover other nodes, thereby increasing the time for discovering a node.

In Wi-Fi Peer-to-peer (P2P) technology standards (version 1.1) of the Wi-Fi Alliance, a discover process for a P2P node is described. This process includes a Scan Phase and a Find Phase, and the Find Phase includes two state: a Listen State and a Search State. Before entering the Scan Phase, a node selects one channel as a Listen Channel from predetermined three social channels, and listens for this channel in the Listen State. Different nodes may select different listen channels, and the time length of the Listen State is a random value. In the Search State, the node searches all of the three social channels within a predetermined time length. If no node was found, the node enters the Listen State again until another node is searched out or the process times out. The reason why the time length of the Listen State is a random value, is to avoid a state of “dead lock”; however, it is necessary for two nodes to spend time performing the listen and search in the same channel at the same time because of this randomness, namely, the time for discovering a node is increased.

In patent application US2007/0171910A1, a wireless node can discover a target node, perform an authentication of the target device and generate a session key, thereby forming a wireless ad-hoc network. In this invention, a node searches all of the available wireless channels to perform a communication operation. It is generally known that there are many wireless channels, for example, at the frequency band of 2.4 GHz. For example, there are 13 available channels in mainland China, there are 11 available channels in Europe and North America, and there are 14 available channels in Japan. Therefore, the time of the search process in this invention is long.

Therefore, it is necessary to provide a rapid node discovery technology to reduce the time for discovering a node.

### SUMMARY OF THE INVENTION

In the related art, it is necessary for a node to search all wireless channels to find other nodes, therefore, it is necessary for two nodes to spend time performing operation in the same channel at the same time. The present invention is made in light of the above problems in the related art. In the present invention, nodes select the same channel directly based on unified data information and perform find and communication, therefore, the time for finding a node can be reduced.

According to an aspect of the present invention, a method for discovering a node in a wireless self-organized network includes the steps of determining, by nodes in the network, a unified node discovery channel based on unified information provided by a trusted third party; and finding the node based on the unified node discovery channel.

According to another aspect of the present invention, an apparatus for discovering a node in a wireless self-organized network includes a determination unit configured to determine a unified node discovery channel based on unified information provided by a trusted third party; and a finding unit configured to find the node based on the unified node discovery channel.

### BRIEF DESCRIPTION OF THE DRAWINGS

The above object and other objects of the present invention will become more apparent from the following detailed description of the embodiments of the present invention when read in conjunction with the accompanying drawings.

FIG. 1 is a schematic drawing illustrating a discovery process of a P2P node described in the technology standard of Wi-Fi Peer-to-Peer (P2P);

FIG. 2 is a flowchart illustrating the node discovery method in a wireless ad-hoc network according to the first embodiment of the present invention;

FIG. 3 is a schematic drawing illustrating a wireless ad-hoc network (ARANet) which the area is limited;

FIG. 4 is a flowchart illustrating a method for determining a unified node discovery channel from the ARANet based on an area encryption key;

FIG. 5 is a flowchart illustrating an operation of finding a node in the unified node discovery channel based on a random encryption key;

FIG. 6 is a flowchart illustrating an operation of sending a probe response message to a node of search via the unified node discovery channel by a node of listen;

FIG. 7 is a flowchart illustrating an operation receiving the probe response message by the node of search;

FIG. 8 is a schematic drawing illustrating a scan process of the technology standard of Wi-Fi Peer-to-Peer (P2P); and

FIG. 9 is a block diagram illustrating an overall configuration of the node discovery apparatus in a wireless self-organized network according to an embodiment of the present invention.

### DETAILED DESCRIPTION OF THE PREFERRED EMBODIMENTS

In the following, embodiments of the present invention are described in detail with reference to the accompanying drawings, so as to facilitate the understanding of the present invention.

It should be noted that, for a node discovery process, a wireless Peer-to-Peer network is equivalent to a wireless ad-hoc network, therefore in the following description of the present invention, the two kinds of expressions are not distinguished, namely, the two kinds of expressions are alternately used.

As described above, in the technology standard (version 1.1) of the Wi-Fi Peer-to-Peer (P2P) of the WiFi Alliance, a node discovery process of P2P node is described. The node discovery method of the present invention follows this technology standard and improves it. Therefore, in order to facilitate the understanding of the present invention, in the following, the discovery process of the P2P node described in the technology standard will be briefly introduced.

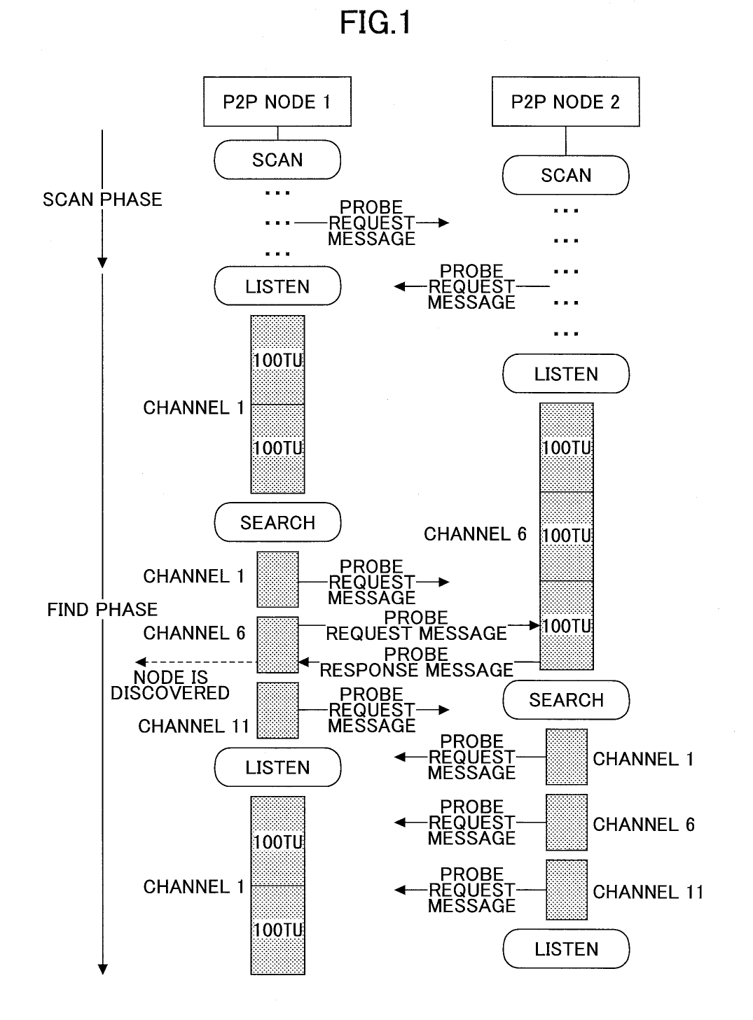

FIG. 1 is a schematic drawing illustrating a discovery process of a P2P node described in the technology standard of Wi-Fi Peer-to-Peer (P2P). In FIG. 1, as an example of the node discovery process in the P2P technology standard, an operation of the node 1 is described. The node 1 first enters a scan phase. In this phase, the node 1 scans all available wireless channels, namely, sends a probe request message in each of the available wireless channels. If the node 1 discovers another node in the scan process, namely, another node (such as the node 2) is listening in a wireless channel when the node 1 scans the wireless channel, and the node 1 receives a probe response message sent by the node 2, the discovery process is over (the scan process will be described in detail in the following). If the node 1 does not find other nodes after scanning all available wireless channels, the node 1 enters find phase. The purpose of the find phase is to make two or more nodes that is finding other nodes perform a find communication in the same wireless channel, and the purpose is achieved by performing switching of nodes between a listen state and a search state. As illustrated in FIG. 1, if the node 1 does not find other nodes in the scan phase, the node 1 enters the find phase and first becomes the listen state. As described above, the nodes select one listen channel in advance before entering the scan phase, and the listen channel does not change in the whole device discovery process. Additionally, the nodes randomly determine the period of the listen time, the period is an integral multiple of 100 time units (TU), and the integral multiple may usually be selected from 1, or 3 randomly. For example, the period of the listen time of the node 1 is 2TU, and the period of the listen time of the node 2 is 3TU. As illustrated in FIG. 1, the node 1 enters the search state, because the node 1 does not receive a probe request message sent by another node in the listen state. In the search state, a node for search performs a search operation in each of the social channels, namely, sends a probe request message. Two nodes can discover each other only when the node for search performs a search operation in a social channel and another node is listening in the social channel at the same time. As illustrated in FIG. 1, the node 2 is in the listen state and is listening in the channel 6 when the node 1 sends the probe request message in the channel 6 of the social channels. At this time, the node 2 receives the probe request message sent by the node 1, and returns the probe response message corresponding to the probe request message. It means that the node 1 discovers the node when the node 1 receives the probe response message.

As an example of the node discovery process in the P2P technology standard, the operation of the node 1 is described. In fact, in the node discovery process, other nodes in FIG. 1, such as the node 2, may also perform the same operation as the node 1, that is, may also go through the scan phase and the find phase, and perform a switch between the listen state and the search state in the find phase.

### First Embodiment

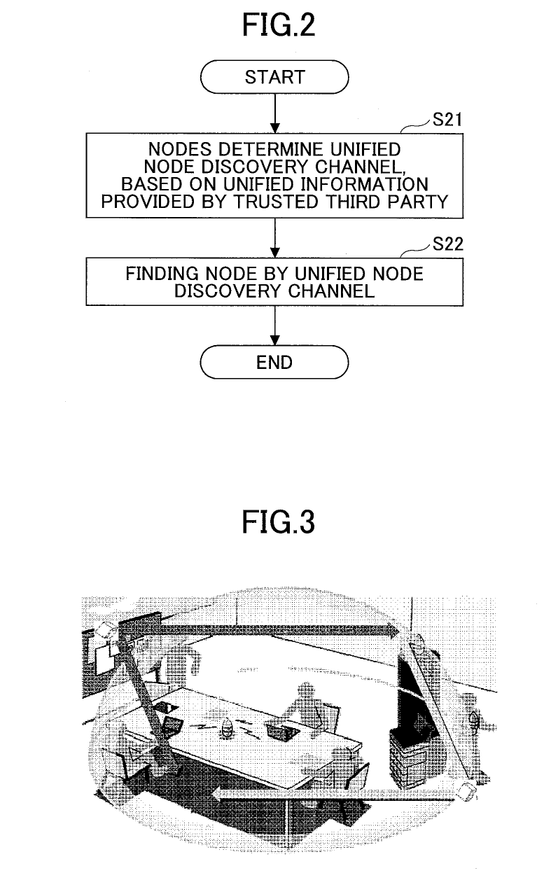

In the node discovery process of the above P2P technology standard, the nodes 1 and 2 spend much time performing the listen operation or the search operation in the same channel at the same time. In the embodiment, nodes performing the node discovery process perform the find operation and the search operation directly in the same channel based on unified data information, therefore the time for finding a node can be reduced. FIG. 2 is a flowchart illustrating the node discovery method in a wireless ad-hoc network according to the first embodiment of the present invention.

As illustrated in FIG. 2, in step S21, nodes in the wireless ad-hoc network determine a unified node discovery channel based on the unified information provided by a trusted third party.

The unified information provided by the trusted third party may be any information as long as it is the same information for all of the nodes in the wireless ad-hoc network. In this way, the nodes perform the same operation for the same unified information and obtain the same result, that is, determine the unified node discovery channel. For example, a section name which a node in the wireless ad-hoc network belongs to, may be used as the unified information, by digitizing the section name (for example, converting to a corresponding binary number or an ASCII code). As another example, for a wireless ad-hoc network which the area is limited (ARANet), besides a section name, an area encryption key may also be used as the unified information. In the following, as an example of the unified information in the present invention, the ARANet and the area encryption key will be described.

The ARANet is a special wireless ad-hoc network, and includes an area previously limited by a method, such as IR, NFC, ultrasound and microwave. The communication between a node within the limited area and a node out of the limited area cannot be performed, even though the two nodes are located in the range of the communication each other. FIG. 3 is a schematic drawing illustrating an ARANet which the area is limited by two transmitters. Since all of the nodes in the ARANet can receive an area encryption key from an area limitation system (i.e., the trusted third party) and the area encryption key is the same for all of the nodes in the ARANet, the area encryption key including an area number may be used as the unified information provided by the trusted third party.

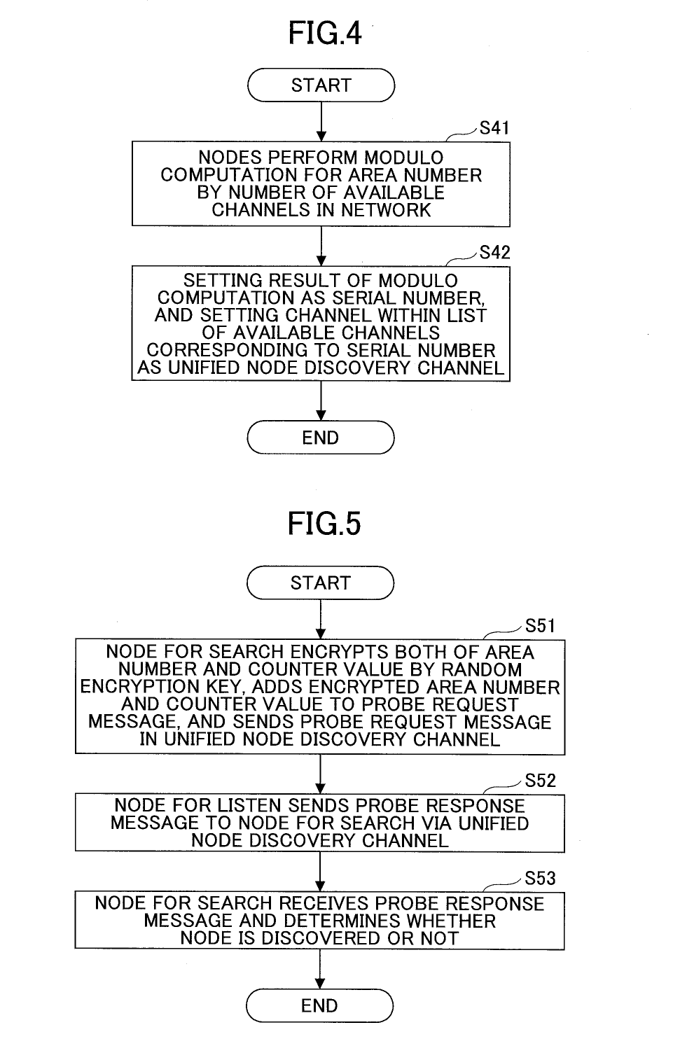

FIG. 4 is a flowchart illustrating a method for determining the unified node discovery channel by nodes in the ARANet based on the area encryption key.

As illustrated in FIG. 4, in step S41, nodes perform a modulo computation, for the area number that is included in the area encryption key, by the number of available channels in the network. In step S42, the result of the modulo computation is set as a serial number, and a channel within a list of the available channels corresponding to the serial number is set as the unified node discovery channel. For example, supposing that the number of the available channels is 13 and the list of the available channels is channel 1, channel 2, channel 3, channel 13, the unified node discovery channel is channel 1 if the result of (area number mod 13) is 0, the unified node discovery channel is channel 2 if the result of (area number mod 13) is 1, the unified node discovery channel is channel 3 if the result of (area number mod 13) is 2, and so on.

The modulo computation illustrated in FIG. 4 is just an example for explaining the present invention, and the present invention is not limited to this. In fact, the unified node discovery channel may be determined by any appropriate way. For example, it may be determined by a binary “AND” operation. That is, the area number and the number of the available channels are converted to binary numbers and an “AND” operation is performed for them, and a corresponding channel is determined by the result of the “AND” operation. For example, supposing the area number is 5, the number of the available channels is 13, the result of the “AND” operation between 0101 and 1101 is 0101, and the fifth channel in the list of the available channels is selected. As another example, the unified node discovery channel may be determined by a sine function sin. That is, a sine calculation for the area number (X) and the number of the available channels (Y) are performed, and a floor function floor(Y×sin(X)) is performed for the calculation result so as to determine a corresponding channel. For example, supposing the area number is 30 and the number of the available channels is 13, the value of floor(13×sin 30) is 6, and the sixth channel in the list of the available channels is selected.

Returning FIG. 2, in step S22, the node is found based on the unified node discovery channel.

After the unified node discovery channel is determined, a listen operation and a search operation are performed by the unified node discovery channel. That is, the node for search sends a probe request message only in the channel, and the node for listen performs the listen operation only in the channel. If the node for search receives a probe response message from a node of listen, it means that another node has been found. The detailed process of finding a node by a certain channel is well known in the art, for example, the process of the find phase described in the above P2P technology standard may be used, and the description is omitted here.

### Second Embodiment

In the node discovery method according to the first embodiment of the present invention, the process of finding a node is accelerated by the unified information provided by the trusted third party; therefore, the unified information is very important and it is necessary to guarantee its safety. As an example of the ARANet, it is necessary to guarantee the safety of the area number, because only the nodes within the same ARANet can exchange information each other. Accordingly, in the embodiment, besides the area number, the area encryption key further includes a random encryption key and a counter value, and safety of the area number is guaranteed, by encrypting the area number and the counter value by the random encryption key.

The node discovery method according to the embodiment is different from the first embodiment in that: the safety of the area number is guaranteed by the random encryption key in the step of performing a node finding process by the unified node discovery channel. The detailed description will be described with reference to FIG. 5.

FIG. 5 is a flowchart illustrating an operation of finding a node in the unified node discovery channel based on a random encryption key. As illustrated in FIG. 5, in step S51, the node for search encrypts both of the area number and the counter value based on the random encryption key, adds the encrypted area number and the counter value into a probe request message, and sends the probe request message in the unified node discovery channel.

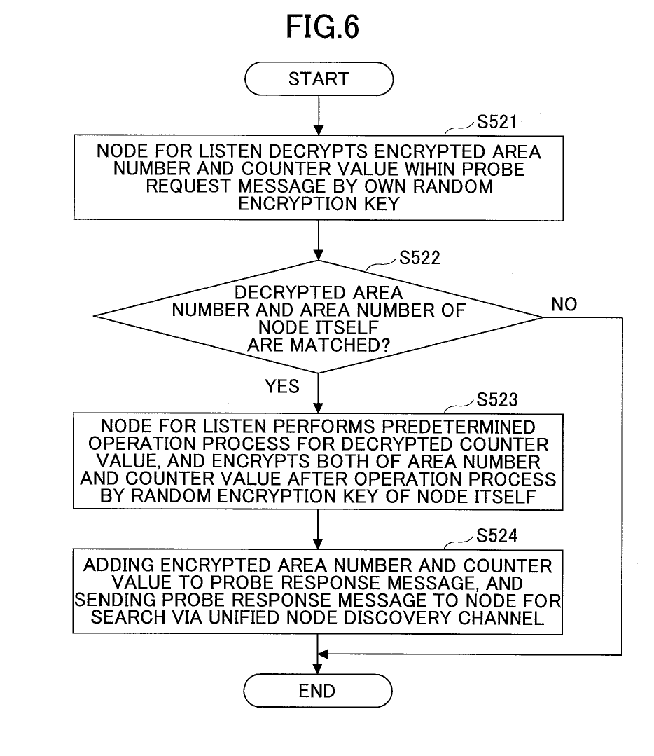

In step S52, the node for listen sends a probe response message to the node for search via the unified node discovery channel. This process will be described in detail with reference to FIG. 6.

As illustrated in FIG. 6, in step S521, the node for listen decrypts the encrypted area number and counter value in the received probe request message by its own random encryption key. In step S522, it is determined whether the decrypted area number and the area number of the node itself are matched or not. Since the area encryption key is the same for each of the nodes in the same ARANet, the node for listen can decode the area number correctly when the node for listen and the node for search are within the same ARANet. If the result of step S522 is YES, in step S523, the node for listen performs a predetermined operation process for the decrypted counter value, and encrypts the area number and the counter value after the operation process by the random encryption key of itself. In this step, the node for listen may perform any predetermined operation process for the counter value, such as adding 1 to the counter value, subtracting 1 from the counter value, or multiplying the counter value by 2. The operation process is predetermined, and cannot be known by the node that is not within the ARANet. If the result of step S522 is NO, the listen process performed by the node for listen is over. In step S524, the encrypted area number and counter value are added into a probe response message, and the probe response message is sent to the node for search via the node discovery channel.

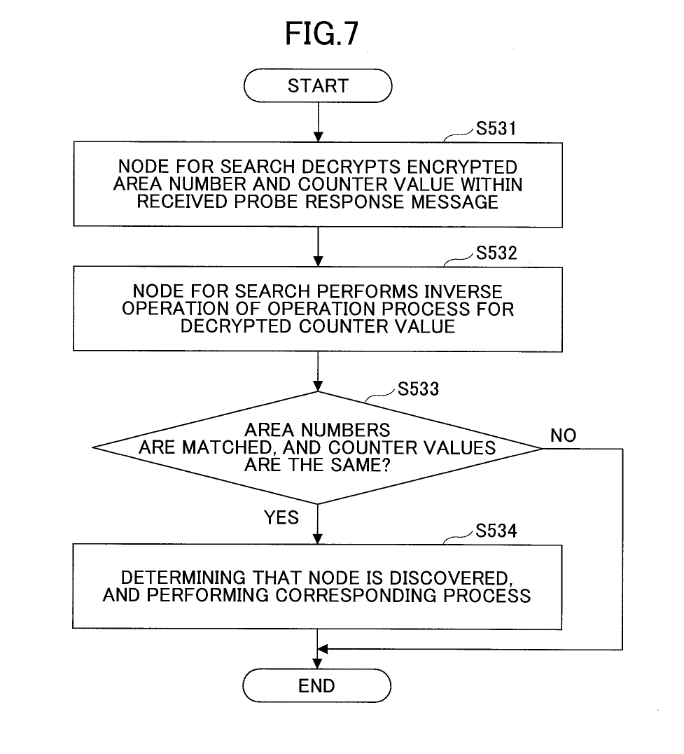

Returning FIG. 5, in step S53, the node for search receives the probe response message and determines whether a node is discovered or not. This process will be described in detail with reference to FIG. 7.

As illustrated in FIG. 7, in step S531, the node for search decrypts the encrypted area number and counter value in the received probe response message. In step S532, the node for search performs an inverse operation of the operation process for the decrypted counter value. The inverse operation is an inverse operation of the predetermined operation process in step S523 of FIG. 6, and the original counter value is restored by performing the inverse operation. For example, the inverse operation is subtracting 1 from the counter value if the operation in step S523 is adding one to the counter value, or the inverse operation is dividing the counter value by 2 if the operation in step S523 is multiplying the counter value by 2. In step S533, it is determined whether the decrypted area number and the area number of the node for search are matched or not and the counter value after the inverse operation and the counter value of the node for search are the same or not. If both of the determination results in step S533 are YES, in step S534, it is determined that a node is discovered, and a corresponding process, such as sending a “node is discovered” message to an upper device, is performed. If any one of the determination results is NO, it means that no node is discovered.

### Third Embodiment

In the following, the node discovery method in the wireless ad-hoc network according to the third embodiment of the present invention will be described.

The node discovery method according to the third embodiment is different from the first embodiment in that: a node scan operation is performed, before the node discovery method described in the first embodiment is performed. The node scan according to the embodiment follows the scan process described in the above technology standard of Wi-Fi Peer-to-Peer (P2P) and improves that.

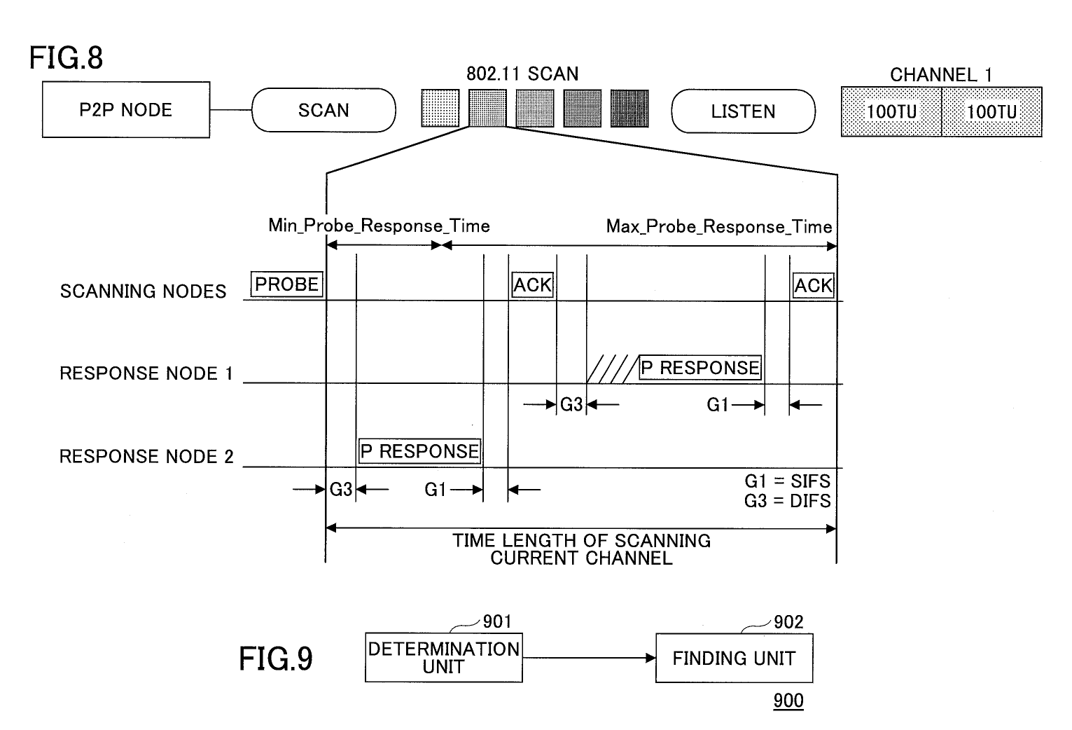

In the scan process of the technology standard of Wi-Fi Peer-to-Peer (P2P), a scan process defined in the IEEE standard (IEEE Standard 802.11-2007) is used. This description will be described in detail with reference to FIG. 8.

As illustrated in FIG. 8, a scanning node sends probe packet in each of the channels, and receives a response within a predetermined minimum probe response time. If the scanning node received a response data packet from, for example, the response node 2 but the receiving of the response data packet is not finished by the end of the minimum probe response time, the scanning node will extend automatically the time length of scanning the current channel to a predetermined maximum probe response time, and continue to receive the uncompleted response data packet in the extended time, and receive a response data packet from another response node (such as response node 1).

In the embodiment, the time of the scan phase is reduced by using the unified information provided by the trusted third party. Specifically, when a node scanning is preformed, the scanning node broadcasts a probe request message in available channels of the network so as to scan other nodes in the network, and receives only probe response messages for the probe request message that are returned from nodes having the unified information. Similarly, as an example of the ARANet, the area number is added into the probe request message broadcast in the scanning node, only the nodes having the same area number (namely, the nodes that are located the same ARANet to the scanning node) are asked to respond to the probe request message, and the scanning node receives only the probe response messages returned from the nodes having the same area number. In this way, the scanning node does not extend the time length of scanning the current channel from the minimum probe response time to the maximum probe response time when the scanning node receives the probe response message from the nodes having different area number; therefore, the likelihood of extending the time length of scanning a channel from the minimum probe response time to the maximum probe response time is reduced, and the time of scan phase is reduced correspondingly.

<Variation>

The node discovery methods according to the embodiments of the present invention is described above, and a possible variation of the method will be described in the following.

In the above embodiments, the node discovery channel is determined from all of the available channels, when the node of the wireless ad-hoc network determines the unified node discovery channel by using the unified information provided by the trusted third party. In a case where a plurality of ARANets exist, if the node discovery channels determined by the ARANets are the same, the mutual interference of the channel will be large and the communication quality will decrease. In order to avoid this problem, the ARANets may select a channel with small channel interference.

Therefore, in a variation of the present invention, an indicator is used to indicate the allowable degree of the channel interference, and the indicator is included in the area encryption key. In this way, when the area encryption key is used to determine the unified node discovery channel, the nodes select a wireless channel that satisfies the interference condition from all of the available wireless channels. That is, for each of the available channels in the network, it is determined whether the interference condition of the channel is superior to the allowable degree indicated by the indicator or not; and it is determined that the channel is the available channel if the interference condition is superior to the allowable degree indicated by the indicator, otherwise the channel is set as an unavailable channel. And then, the unified node discovery channel is determined by using the area number and the information of the redefined available channels. It should be noted that, since the ARANet is usually configured in a small area, it may be considered that the interference in this area is the same, and the available channels redefined by the nodes in the area is the same.

<Overall Configuration of Node Discovery Apparatus in Wireless Self-Organized Network>

FIG. 9 is a block diagram illustrating an overall configuration of the node discovery apparatus in wireless self-organized network according to an embodiment of the present invention.

As illustrated in FIG. 9, the node discovery apparatus 900 includes a determination unit 901 configured to determine a unified node discovery channel based on unified information provided by a trusted third party; and a finding unit 902 configured to find the node based on the unified node discovery channel. The node discovery apparatus 900 is configured in the each of the nodes, therefore, the nodes can discover other nodes rapidly by using the node discovery apparatus.

The basic principle of the present invention is described above with reference to the embodiments. Any one or all of the steps or units of the method or apparatus according to the present invention may be implemented by hardware, software or their combination in any one of computing devices (including a processor, a storage medium, etc.) or a network of computing devices, and it can be implemented by persons skilled in the art who have read the specification of the present application.

Therefore, the present invention may also be realized by a program or a set of programs running on any one of computing devices. The computing devices may be well known general-purpose devices. Therefore, the present invention may also be implemented by providing a program product including program codes for implementing the method or apparatus. That is to say, the program product also belongs to the present invention, and a storage medium storing the program product also belongs to the present invention. Obviously, the storage medium may be any one of well-known storage media or storage media which are to be developed.

In addition, in the apparatus or method of the present invention, units or steps may be divided and/or recombined. The division and/or recombination should be regarded as an equivalent embodiment of the present invention. Steps of the above method may be performed in time order, however the performing sequence is not limited to the time order. Any steps may be performed in parallel or independently.

The above descriptions of the embodiments are just examples, and various modifications, replacements or combinations may be made without departing from the scope of the present invention by persons skilled in the art.

The present application is based on and claims the benefit of priority of Chinese Priority Application No. 201310064506.4 filed on Feb. 28, 2013, the entire contents of which are hereby incorporated by reference.

What is claimed is:

1. A method for discovering a node in a wireless self-organized network, comprising the steps of:
determining, by nodes in the network, a unified node discovery channel based on unified information provided by a trusted third party; and
finding the node based on the unified node discovery channel.

2. The method for discovering a node according to claim 1,
wherein the network is a wireless self-organized network of which an area is limited, the unified information is an area encryption key, and the area encryption key includes an area number.

3. The method for discovering a node according to claim 2,
wherein the step of determining the unified node discovery channel based on the unified information provided by the trusted third party, comprises the steps of
performing a modulo computation for the area number by the number of available channels in the network, and
setting a result of the modulo computation as a serial number, and setting a channel within a list of the available channels corresponding to the serial number as the unified node discovery channel.

4. The method for discovering a node according to claim 2,
wherein the area encryption key further includes an indicator for indicating an allowable degree of channel interference.

5. The method for discovering a node according to claim 4,
wherein the step of determining the unified node discovery channel based on the unified information provided by the trusted third party, further comprises the steps of
determining, for each of a plurality of available channels in the network, whether an interference condition of the channel is superior to the allowable degree indicated by the indicator or not, and
determining that the channel is the available channel if it is determined that the interference condition is superior to the allowable degree indicated by the indicator, otherwise setting the channel as an unavailable channel.

6. The method for discovering a node according to claim 2,
wherein the step of finding the node based on the unified node discovery channel, comprises the step of performing a listen operation and a search operation in the unified node discovery channel.

7. The method for discovering a node according to claim 6,
wherein the area encryption key further includes a random encryption key and a counter value.

8. The method for discovering a node according to claim 7,
wherein the step of performing the listen operation and the search operation in the unified node discovery channel, comprises the steps of
by a node for search, encrypting both of the area number and the counter value based on the random encryption key, adding the encrypted area number and the counter value into a probe request message, and sending the probe request message in the unified node discovery channel,
by a node for listen, decrypting the encrypted area number and counter value in the received probe request message, and performing a predetermined operation process for the decrypted counter value, encrypting the area number and the counter value after the operation process by a random encryption key of the node for listen, adding the encrypted area number and counter value into a probe response message and sending the probe response message to the node for search via the node discovery channel when the decrypted area number and an area number of the node for listen are matched, and
by the node for search, decrypting the encrypted area number and counter value in the received probe response message, performing an inverse operation of the operation process for the decrypted counter value, and determining that the node is discovered when the decrypted area number and the area number of the node for search are matched and the counter value after the inverse operation and the counter value of the node for search are the same.

9. The method for discovering a node according to claim 2, further comprising the step of
by the nodes in the network, broadcasting a probe request message in available channels of the network so as to scan other nodes in the network, and receiving only probe response messages for the probe request message that are returned from nodes having the unified information, before determining the unified node discovery channel based on the unified information provided by the trusted third party.

10. An apparatus for discovering a node in a wireless self-organized network, comprising:
a determination unit configured to determine a unified node discovery channel based on unified information provided by a trusted third party; and
a finding unit configured to find the node on the unified node discovery channel.
